(19) United States
(12) Patent Application Publication
(10) Pub. No.: US 2005/0105121 A1
(43) Pub. Date: May 19, 2005

(54) Image processing method, image processor, and program

(75) Inventor: Yasuhiko Hirano, Kanagawa (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/985,672

(22) Filed: Nov. 10, 2004

(30) Foreign Application Priority Data
Nov. 19, 2003 (JP) 2003-389273

(51) Int. Cl. G06F 15/00

(52) U.S. Cl. 358/1.14

(57) ABSTRACT

An image processing system and method is disclosed. The method includes steps of receiving information about a first secure job to be output; receiving a user ID that identifies the first secure job; determining whether a second secure job corresponding to the user ID was previously output; generating a notification signal if it is determined that the second secure job was previously output; and using authentication information such as a password to execute both the first secure job and the second secure job.

This application claims priority from Japanese Patent Application No. 2003-389273 filed Nov. 19, 2003, which is hereby incorporated by reference herein.

### BACKGROUND OF THE INVENTION

1. Field of the Invention

The present invention relates to image processing and particularly to image processing of secure jobs.

2. Description of the Related Art

In recent years, the promotion of high definition and low cost in laser-beam printers (LBPs) and ink-jet printers (IJPs) has caused rapid spread of nonimpact printers, which are capable of printing data onto a recording medium such as paper without making a physical impact. Multi function printers (MFP), which include scanning, facsimile and copying functionalities are also becoming popular among users.

This kind of MFP includes a network interface for controlling an interface function to a network, and thus can be shared between a plurality of users through computers connected to the network. By sharing the MFP having various functions between users, space for office automation equipment can be saved and usability of the equipment can be improved.

MFPs operate as follows: document image or output information described in a page description language (PDL) is converted to image data, the image data is compressed and temporarily stored in a hard disk drive (HDD) or a dynamic random access memory (DRAM), and when image data of a plurality of pages or sets is accumulated, the entire accumulated image data is output in real time by decompressing it.

In this kind of MFP, time for decompressing the output information described in the PDL varies significantly depending on the contents of data. However, many conventional MFPs are unable to simultaneously perform various functions such as the copy function, the scanner function, the printer function, the facsimile function, etc.

Also, conventional MFPs for outputting confidential information when an ID card is inserted into the MFP are known. This is the so-called confidential printing system.

In the known MFP, however, when a plurality of users simultaneously provide instructions of a printing operation, output print jobs are mixed on an output tray. As a result, each user may have a trouble finding his/her output print job when he/she comes to get the print job after the printing operation.

To avoid such problems, an output tray is shifted for each job so that each job can be distinguished from each other, or a bin of a sorter is assigned to each job.

However, these methods are not ultimate solutions, because the output tray or the bins of the sorter become full in a short time if the MFP is shared between many users.

Also, after a user has specified a printing operation so as to execute a print job, if he/she leaves the output print job on an output tray for long time or he/she forgets to pick up the print job, printed sheets pile up on the output tray and it may take a long to find his/her print job.

Further, the user cannot find his/her output print job if another user takes it away by mistake.

The above-mentioned problems are further exacerbated when confidential documents are printed since such confidential documents can be viewed at the printer by other parties or they can be erroneously picked up by another.

To maintain confidentiality, a user can specify “secure printing” when the document is printed. Then, a password is attached to the print job for secure printing and the print job is transmitted to an MFP. The MFP stores the print job for secure printing in a mass storage device, such as a hard disk drive (HDD), of the MFP without executing an actual printing operation. Then, after the user has specified the print job for secure printing and input a password corresponding to the print job through a user interface, such as a panel of the MFP, the print job for secure printing is read from the mass storage device, such as the HDD of the MFP, and an actual printing operation is executed. In this way, confidentiality of output document information can be ensured.

However, even with such a system, some disadvantages still exist. That is, after a user has specified a print job for secure printing through an interface, such as a panel of the MFP, so as to execute the print job, if he/she does not input a password for the print job for secure printing and leaves the print job unprocessed for a long time, or if he/she forgets to perform a printing operation for the print job, the print job remains in the mass storage device, such as the HDD of the MFP, and thus the print job for secure printing may be left unprocessed for a long time.

If the user has forgotten the password for the preexisting job, the preexisting job can no longer be printed or it cannot be printed without significant inconvenience to the user.

### SUMMARY OF THE INVENTION

The present invention resolves one or more of the above-described problems, and provides the advantage that confidential job information can be securely output without the associated disadvantages of the related art.

According to an aspect of the present invention, an image processing method includes a first receiving step of receiving first confidential job information and user identifying information; a search step of searching for unprocessed second confidential job information, other than the first confidential job information, corresponding to the user identifying information; and a transmitting step of transmitting a notice if the second confidential job information is found.

Other features and advantages of the present invention will be apparent from the following description taken in conjunction with the accompanying drawings, in which like reference characters designate the same or similar parts throughout thereof.

### BRIEF DESCRIPTION OF THE DRAWINGS

FIG. 1 illustrates an image processing system having an MFP (multi function printer) in communication with PCs (personal computers) in accordance with an embodiment of the present invention.

FIG. 2 illustrates MFP and PC components of an image processing system in accordance with an embodiment of the present invention.

FIG. 3 illustrates a method for outputting a job in accordance with an embodiment of the present invention.

FIG. 4 shows a dialog for notifying a user of unprocessed jobs in accordance with an embodiment of the present invention.

FIG. 5 shows a list of unprocessed jobs displayed for viewing in accordance with an embodiment of the present invention.

FIG. 6 shows a dialog box for receiving a user password in accordance with an embodiment of the present invention.

FIG. 7 shows a list of unprocessed jobs displayed for viewing on a multi function printer (MFP) in accordance with an embodiment of the present invention.

FIG. 8 shows a dialog box for receiving a user password in a print operation mode of the MFP in accordance with an embodiment of the present invention.

FIG. 9 is a flowchart illustrating a second embodiment of the present invention.

### DETAILED DESCRIPTION OF THE EMBODIMENTS

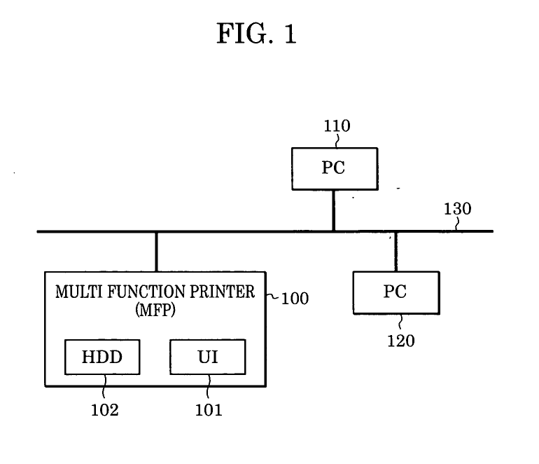

Hereinafter, embodiments of the present invention will be described with reference to the drawings. FIG. 1 illustrates the configuration of an image processing system of the embodiments of the present invention. In the figure, the system includes a multi function printer (MFP) 100 having a copy function, a scanner function, a printer function, a facsimile function, and so on. The MFP 100 includes a user interface (UI) 101, such as a panel; and a hard disk drive (HDD) 102 functioning as a mass storage device. Also, the image processing system includes personal computers (PCs) 110 and 120 placed in an office or the like. The MFP 100 and the PCs 110 and 120 are connected through a network 130, such as an intracompany local area network (LAN).

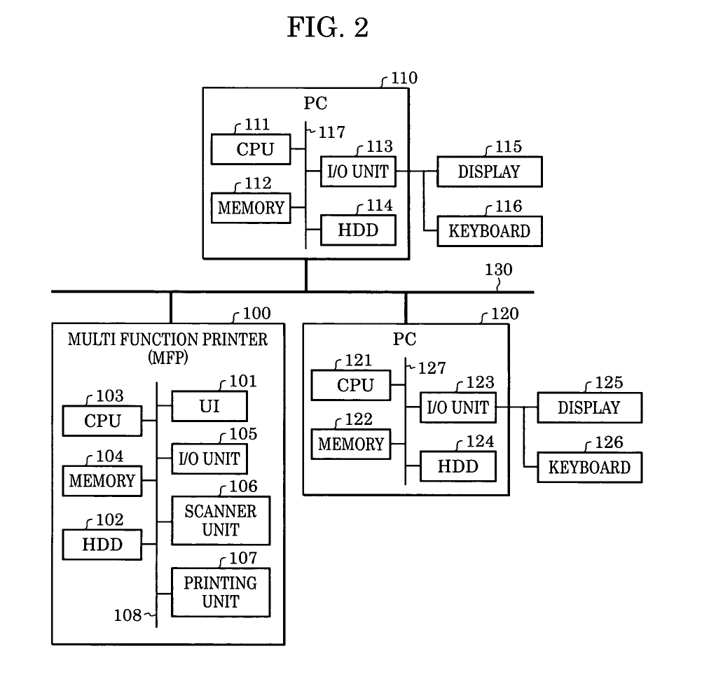

FIG. 2 specifically illustrates the configuration of the image processing system of the embodiments of the present invention. In FIG. 2, as in FIG. 1, the system includes the MFP 100, which includes the UI 101 such as a panel; the HDD 102 functioning as a mass storage device; a central processing unit (CPU) 103 for controlling the MFP; a memory 104 functioning as a temporary storage area for overall processing in the MFP; an input/output unit 105 such as a network interface; a scanner unit 106 for scanning-in image data; a printing unit 107 for printing image data scanned-in by the scanner unit 106; and a system bus 108 for connecting each of the above-mentioned blocks.

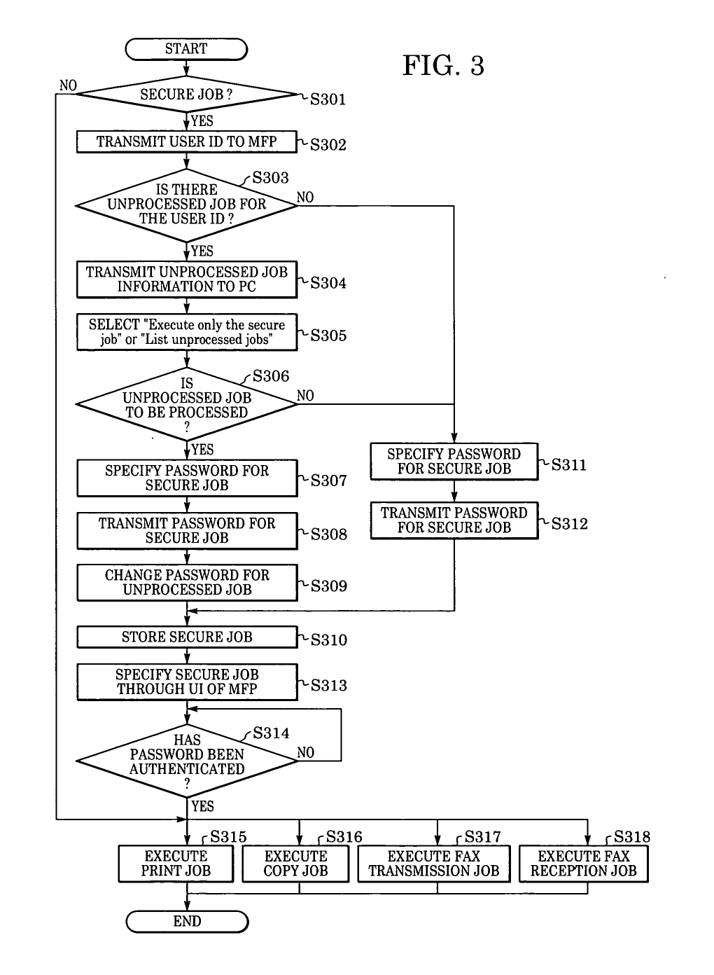

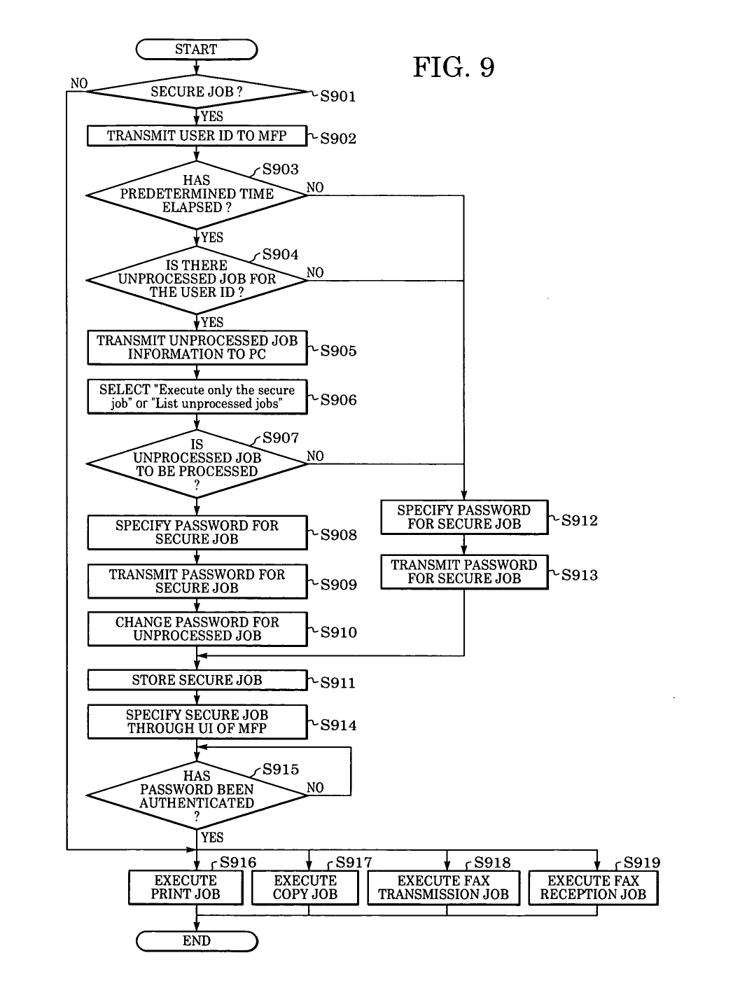

The MFP 100 performs the processes illustrated in FIGS. 3 and 9, which are performed when the CPU 103 executes a computer program stored in the memory 104 or the HDD 102.

Also, as in FIG. 1, the system includes the PC 110, which includes a central processing unit (CPU) 111 for controlling the PC 110; a memory 112 functioning as a temporary storage area for overall processing in the PC 110; an input/output unit 113 such as a network interface; a hard disk drive (HDD) 114 functioning as a mass storage device; a display 115 for outputting/displaying information input to the PC 110; a keyboard 116 for inputting data to the PC 110; and a system bus 117 for connecting each of the above-mentioned components.

The PC 110 performs the processes illustrated in FIGS. 3 and 9, which are performed when the CPU 111 executes a computer program stored in the memory 112 or the HDD 114.

Also, as in FIG. 1, the system includes the PC 120, which includes a central processing unit (CPU) 121 for controlling the PC 120; a memory 122 functioning as a temporary storage area for overall processing in the PC 120; an input/output unit 123 such as a network interface; a hard disk drive (HDD) 124 functioning as a mass storage device; a display 125 for outputting/displaying information input to the PC 120; a keyboard 126 for inputting data to the PC 120; and a system bus 127 for connecting each of the above-mentioned components.

The PC 120 performs the processes illustrated in FIGS. 3 and 9, which are performed when the CPU 121 executes a computer program stored in the memory 122 or the HDD 124.

In addition, as in FIG. 1, the system includes a network 130 for connecting the MFP 100 and the PCs 110 and 120, such as an intracompany LAN.

When the MFP 100 having the above-described configuration receives output information which is transmitted from the personal computer 110 or 120 and which is described in a page description language (PDL), the CPU 103 converts the information into image data so that the printing unit 107 of the MFP 100 can receive it or compresses image data captured through the scanner unit 106 of the MFP 100. Then, the CPU 103 temporarily stores the image data in the memory 104, which functions as a temporary storage area of the MFP 100, and then performs facsimile transmission or the like in accordance with instructions from the PC 110 or 120.

FIG. 3 is a flowchart illustrating a first embodiment of the present invention. Hereinafter, a procedure in the first embodiment of the present invention will be described with reference to FIGS. 2 to 8.

A user wishing to print a job uses the PC 110 (FIG. 2) to initiate printing. A control program stored on the HDD 114 is then executed by the CPU 111 to determine whether the print job is a secure job, that is, whether it requires confidentiality (S301). If the print job is a secure job, the secure job information and identifying information (ID) corresponding to the user are transmitted from the PC 110 to the MFP 100 according to the control program (S302).

The MFP 100 reads a control program stored in the HDD 102 of the MFP 100, and the CPU 103 executes the control program. Accordingly, the MFP 100 receives the secure job information and the ID corresponding to the user from the PC 110, and then searches the large-capacity HDD 102 storing jobs for an unprocessed job, other than the secure job, corresponding to the user ID (S303).

If one or more unprocessed jobs, other than the secure job, corresponding to the user ID are found, the MFP 100 transmits information of the unprocessed jobs to the PC 110, which has transmitted the secure job (S304).

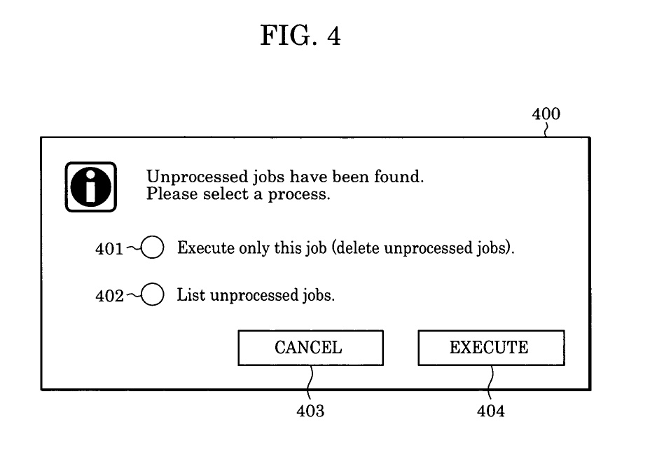

In this case, when the unprocessed jobs are found and the information thereof is transmitted from the MFP 100 to the PC 110, a notice is displayed to the user as shown in FIG. 4.

FIG. 4 is a dialog which is shown to the user when the unprocessed jobs are found and the information thereof is transmitted to the PC 110.

In the figure, reference numeral 400 denotes the dialog displayed on the display of the PC operated by the user. The dialog 400 includes radio buttons 401 and 402, either of which is to be selected by the user; a cancel button 403 used for canceling processing for a processing message displayed in the dialog 400; and an execution button 404 used for executing processing for a processing message displayed in the dialog 400.

Referring back to FIG. 3, when the user is notified that unprocessed jobs other than the secure job have been found, he/she selects one of “Execute only the secure job” (delete the unprocessed jobs other than the secure job) and “List unprocessed jobs” (S305). Although not shown, the user may be asked to select further options. For example, the user may be asked to “execute secure job only,” which executes the secure job without deleting unprocessed jobs.

When the user selects “List unprocessed jobs” (S306), the PC 110 displays a list of the unprocessed jobs on the display 115.

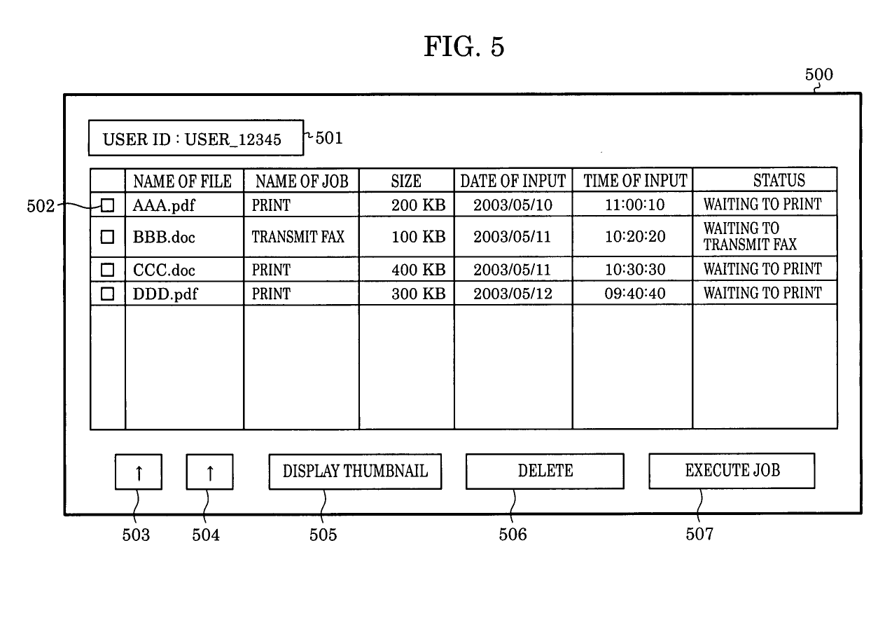

FIG. 5 is a dialog of the list displayed on the display 115 of the PC 110 after the user has selected “List unprocessed jobs”.

In the figure, reference numeral 500 denotes the dialog displayed on the display of the PC operated by the user. The dialog 500 includes ID information 501 corresponding to the user; check boxes 502 used for selecting one or more of the unprocessed jobs; cursors 503 and 504 used for selecting one or more of the unprocessed jobs; a button 505 for “display thumbnail”, which is used for checking image data of a selected unprocessed job in a small-scale display; a delete button 506 for deleting a selected unprocessed job; and a job execution button 507 for executing a selected unprocessed job. Alternatively, this dialog 500 may be displayed on the MFP 100.

The user checks the check box 502 to select one or more unprocessed job(s) on the list, and then selects the execution button 507 to execute the selected unprocessed job(s). Then, in S307 (FIG. 3), the user specifies a password for the secure job and the selected unprocessed job(s).

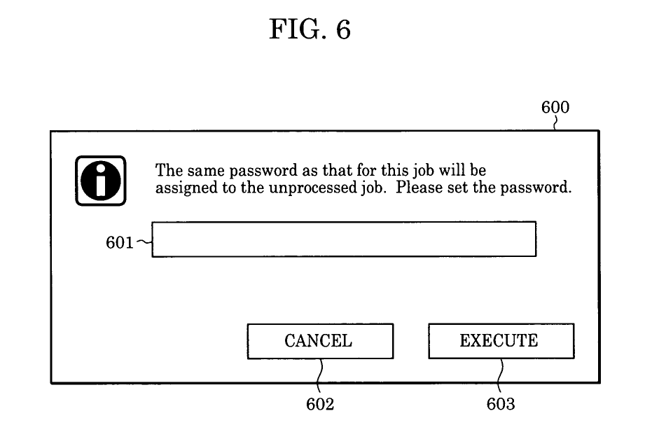

FIG. 6 is a dialog for specifying a password, which is displayed on the display 115 of the PC 110 after the user has selected the secure job and the unprocessed job(s) and pressed the execution button.

In the figure, reference numeral 600 denotes the dialog displayed on the display of the PC operated by the user. The dialog 600 includes an area 601 in which a password for the secure job and the unprocessed job(s) selected from the list is to be input by the user; a cancel button 602 for canceling a setting performed according to the password setting message displayed in the dialog 600; and an execution button 603 for executing processing according to the processing message displayed in the dialog 600.

Referring back to FIG. 3, after the password for the secure job and the unprocessed job(s) selected from the list has been specified, the PC 110 transmits the password, the secure job, and the unprocessed job(s) to the MFP 100 (S308).

Then, the MFP 100 changes the password for the unprocessed job(s) transmitted together with the secure job (S309), the password having been stored in the HDD 102 functioning as a mass storage device. That is, the password for the secure job and that for the unprocessed job(s) become the same.

In the MFP 100, the secure job and the unprocessed job(s) with the same password are stored in the HDD 102 functioning as a mass storage device (S310). The secure job is stored by being associated with the password and the user ID.

When the user specifies the secure job through the UI 101 of the MFP 100 (S313), the MFP 100 authenticates the password, which is now the same for the secure job and the unprocessed job(s)(S314). For example, if the password entered by the user matches that of the secure job, the following process is performed.

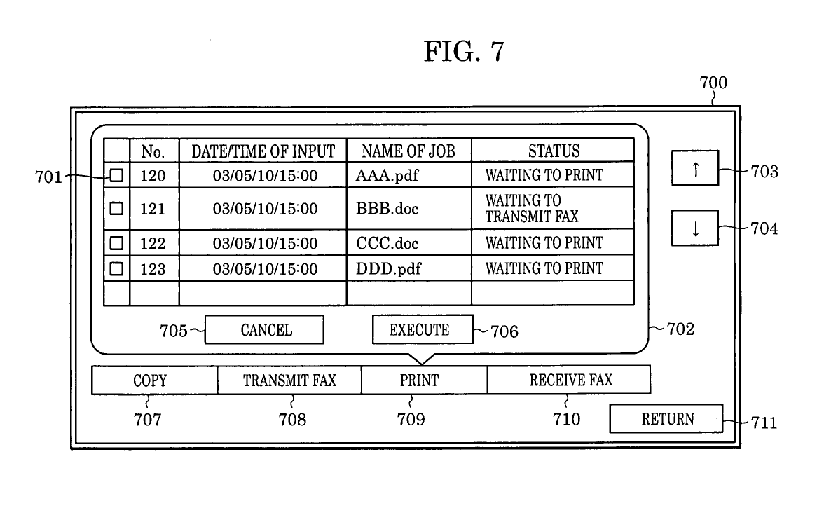

FIG. 7 is a dialog box displayed on the UI 101 of the MFP 100 (FIG. 2) in accordance with an embodiment of the present invention.

In the figure, reference numeral 700 denotes the dialog box displayed on the UI 101. The dialog 700 has a number of features including check boxes 701 for selecting both the secure job and the unprocessed job(s); a list 702 showing the secure job and the unprocessed job(s); cursors 703 and 704 for scrolling over the jobs on the display list; a cancel button 705 for canceling execution of the secure job and the unprocessed job(s); and an execution button 706 for executing the secure job and the unprocessed job(s). The dialog 700 also includes a copy-mode button 707 for selecting a copy operation mode in the MFP 100; a fax-transmission-mode button 708 for selecting a fax transmitting operation mode in the MFP 100; a print-mode button 709 for selecting a print operation mode in the MFP 100; a fax-reception-mode button 710 for selecting a fax receiving operation mode in the MFP 100; and a return button 711 for returning to the previous screen from a dialog screen displayed on the UI 101 of the MFP 100.

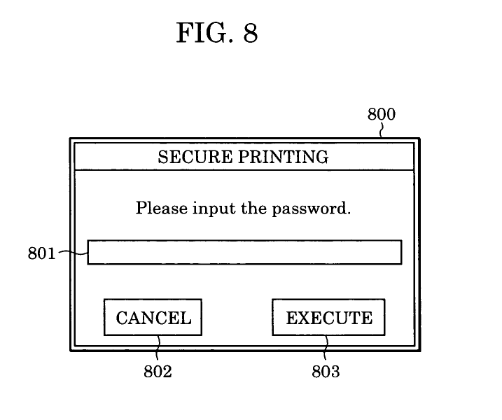

FIG. 8 is a dialog box displayed on the UI 101 of the MFP 100 when the print operation mode is selected in accordance with an embodiment of the present invention.

In FIG. 8, reference numeral 800 denotes the dialog box displayed on the UI 101 of the MFP 100. The dialog 800 includes an area 801 in which the password for the secure job and the unprocessed job(s) selected from the list is to be input by the user; a cancel button 802 for canceling setting of the password which is set according to the password setting message displayed in the dialog 800; and an execution button 803 for executing processing according to the processing message displayed in the dialog 800.

Referring back to FIG. 3, in step (S314), the password for the secure job and the unprocessed job(s) is authenticated. If the authentication is successful, depending on the job type, the MFP 100 executes all of the jobs including the secure job and the unprocessed job(s). For example, the print operation mode is executed if the secure job is a print job (S315); the copy operation mode is executed if the unprocessed job is a copy job (S316); the fax transmitting operation mode is executed if the unprocessed job is a fax transmission job (S317); and the fax receiving operation mode is executed if the unprocessed job is a fax reception job (S318).

On the other hand, referring back to step (S303) of FIG. 3, if there is no unprocessed job corresponding to the user ID, the user specifies the password for the secure job (S311) and the PC 110 transmits the password for the secure job to the MFP 100 (S312).

Then, in the MFP 100, the secure job is stored in the HDD 102 functioning as a mass storage device (S310).

Thereafter, the secure job is processed for output by the MFP 100. That is, the print operation mode is executed if the secure job is a print job (S315); the copy operation mode is executed if the secure job is a copy job (S316); the fax transmitting operation mode is executed if the secure job is a fax transmission job (S317); and the fax receiving operation mode is executed if the secure job is a fax reception job (S318).

If no unprocessed job is processed in step S306, the process proceeds to step S311, then to steps S312, S313, S314 and one of S315, S316, S317 and S318 as described above.

FIG. 9 illustrates a method of processing performed when secure jobs are sequentially transmitted in the first embodiment in accordance with a second embodiment of the present invention.

A user wishing to output a print job uses the PC 110 (FIG. 2) to initiate printing. A control program stored on HDD 114 and executed by the CPU 111 then determines whether the print job is a secure job, that is, whether it requires confidentiality (S901). If the print job is a secure job, the secure job information and identifying information (ID) corresponding to the user are transmitted from the PC 110 to the MFP 100 according to the control program (S902).

The MFP 100 reads a control program stored in the HDD 102 of the MFP 100, and the CPU 103 executes the control program. Accordingly, the MFP 100 receives the secure job information and the ID corresponding to the user from the PC 110, and then compares a predetermined time with the time elapsed since the previous secure job for the ID corresponding to the user was received (S903). If the elapsed time since the previous secure job was received is longer than the predetermined time, the MFP 100 searches the large-capacity HDD 102 storing jobs for an unprocessed job, other than the secure job, corresponding to the user (S904).

If one or more unprocessed jobs, other than the secure job, corresponding to the user ID are found, the MFP 100 transmits information of the unprocessed jobs to the PC 110, which has transmitted the secure job (S905).

When the user is notified that unprocessed jobs other than the secure job have been found, he/she selects one of “Execute only the secure job” (delete the unprocessed jobs other than the secure job) and “List unprocessed jobs” (S906).

When the user selects “List unprocessed jobs” (S907), the PC 110 displays a list of the unprocessed jobs on the display 115.

The user checks the check box 502 to select one or more unprocessed job(s) on the list, and then selects the execution button 507 to execute the selected unprocessed job(s). Then, in step S307 (FIG. 3), the user specifies a password for the secure job and the selected unprocessed job(s) (S908).

After the password for the secure job and the unprocessed job(s) selected from the list has been specified, the PC 110 transmits the password, the secure job, and the unprocessed job(s) to the MFP 100 (S909).

Then, the MFP 100 changes the password for the unprocessed job(s) transmitted together with the secure job (S910), the password having been stored in the HDD 102 functioning as a mass storage device. That is, the password for the secure job and that for the unprocessed job(s) become the same.

In the MFP 100, the secure job and the unprocessed job(s) with the same password are stored in the HDD 102 functioning as a mass storage device (S911). The secure job is stored by being associated with the password and the user ID.

When the user specifies the secure job through the UI 101 of the MFP 100 (S914), the MFP 100 authenticates the password, which is now the same for the secure job and the unprocessed job(s)(S915).

Upon successful authentication, the MFP 100 executes the secure job and the unprocessed job(s). For example, the print operation mode is executed if the secure job is a print job (S916); the copy operation mode is executed if the unprocessed job is a copy job (S917); the fax transmitting operation mode is executed if the unprocessed job is a fax transmission job (S918); and the fax receiving operation mode is executed if the unprocessed job is a fax reception job (S919).

Referring back to step S903, on the other hand, if the elapsed time since the previous secure job for the user ID was received is shorter than the predetermined time, or if there is no unprocessed job for the user ID (S904), the user specifies the password for the secure job (S912) and the PC 110 transmits the password for the secure job to the MFP 100 (S913).

Then, in the MFP 100, the secure job is stored in the HDD 102 functioning as a mass storage device (S911).

Thereafter, the secure job is processed for output by the MFP 100. That is, the print operation mode is executed if the secure job is a print job (S916); the copy operation mode is executed if the secure job is a copy job (S917); the fax transmitting operation mode is executed if the secure job is a fax transmission job (S918); and the fax receiving operation mode is executed if the secure job is a fax reception job (S919).

If no unprocessed job is processed in step S907, the process proceeds to step S912 and other subsequent steps shown in FIG. 9 as previously described.

The above-described secure job (confidential job) includes print job information for performing a printing operation; copy job information for performing a copying operation; scan job information for performing a scanning operation; facsimile transmission/reception job information for transmitting/receiving a facsimile; or e-mail transmission/reception job information for transmitting/receiving an e-mail. Herein, the confidential job includes a job to which a confidential printing mode is set as its attribute or is set through an operation panel of the MFP. When the confidential printing mode is set, the job is stored in the hard disk of the MFP and is output or printed by the MFP after the user has input a password thereto.

The MFP can process digital images. Since the time for decompressing output information described in a PDL varies significantly depending on the contents of each data, various functions of the MFP can be simultaneously executed. For example, the copying, scanning, printing, and faxing functions can typically be simultaneously executed. After image data of a plurality of pages or sets has been accumulated, the MFP outputs the entire accumulated image data in real time by decompressing it. Accordingly, this allows other MFP functions to remain operable even during a print job.

As described above, in the first and second embodiments, the MFP can notify the user that one or more unprocessed secure jobs remain by displaying the dialogs shown in FIGS. 4 and 5. In a case where confidentiality of output document information should be ensured, even if the user leaves for a long time or forgets a specified secure job without executing it, the MFP notifies the user of the unprocessed secure job when the user specifies a next secure job. Accordingly, the user can check a list of unprocessed job(s) and execute them. In this way, the secure jobs can be prevented from being left in an unprocessed state.

Further, as shown in FIG. 6, the same password as that for a new secure job can be assigned to an unprocessed secure job. In a case where confidentiality of output document information should be ensured, even if the user forgets the password for a once-specified secure job, he/she can change the password to the same password as that for a next-specified new secure job. Accordingly, secure jobs can be prevented from being left in an unprocessed state.

Further, in the second embodiment (FIG. 9), a predetermined amount of time is used to initiate searching and hence determine the existence of unprocessed jobs. Accordingly, when the user sequentially specifies a plurality of secure jobs within the predetermined time, a notice of unprocessed jobs is not sent to the user.

These embodiments can be realized when a computer executes a program. Also, a unit for supplying the program to the computer, for example, a computer-readable recording medium such as a CD-ROM containing the program or a transmission medium such as the Internet for transmitting the program, can be applied as an embodiment of the present invention. Also, a computer program product such as a computer-readable recording medium containing the program can be applied as an embodiment of the present invention. The program, recording medium, transmission medium, and computer program product are included in the scope of the present invention. As the recording medium, the followings can be used: a flexible disk, a hard disk, an optical disk, a magneto-optical disk, a CD-ROM, a magnetic tape, a nonvolatile memory card, a ROM, and so on.

Hereinafter, examples of the present invention will be described.

In an image processing system, an image processor and an information processor are connected through a network. The image processor may include a receiving unit for receiving first confidential job information and user identifying information; a search unit for searching for unprocessed second confidential job information, other than the first confidential job information, corresponding to the user identifying information; and a transmitting unit for transmitting a notice if the second confidential job information is found. The information processor may include a transmitting unit for transmitting first confidential job information and user identifying information; and a receiving unit for receiving information about whether or not unprocessed second confidential job information, other than the first confidential job information, corresponding to the user identifying information exists.

As another embodiment, a computer-readable recording medium containing a program is provided. The program allows a computer to execute: a first receiving step of receiving first confidential job information and user identifying information; a search step of searching for unprocessed second confidential job information, other than the first confidential job information, corresponding to the user identifying information; and a transmitting step of transmitting a notice if the second confidential job information is found.

As still another embodiment, a computer-readable recording medium containing a program is provided. The program allows a computer to execute: a first transmitting step of transmitting first confidential job information and user identifying information; and a receiving step of receiving information about whether or not unprocessed second confidential job information, other than the first confidential job information, corresponding to the user identifying information exists.

While the present invention has been described with reference to what are presently considered to be embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. An image processing method comprising:
a first receiving step of receiving first confidential job information and user identifying information;
a search step of searching for unprocessed second confidential job information, other than the first confidential job information, corresponding to the user identifying information; and
a transmitting step of transmitting a notice if the second confidential job information is found.

2. The image processing method according to claim 1, further comprising an executing step of executing processing of the first and/or second confidential job information when instructions to execute the first and/or second confidential job information are provided by inputting a password.

3. The image processing method according to claim 2, wherein, in the executing step, the first and second confidential job information are simultaneously processed when instructions to execute the first and second confidential job information are provided.

4. The image processing method according to claim 1, further comprising:
a second receiving step of receiving a first password corresponding to the first confidential job information;
an input step of inputting a second password by a user for executing the first confidential job information; and
an executing step of executing processing of the first confidential job information if the first password matches the second password.

5. The image processing method according to claim 4, further comprising a password setting step of setting the first password, which is for the first confidential job information, to the password for the second confidential job information if the second confidential job information is found.

6. The image processing method according to claim 1, wherein, in the search step, the second confidential job information is searched for if the first confidential job information is received after a predetermined time has elapsed since the previous confidential job information was received, but is not searched for if the predetermined time has not elapsed.

7. The image processing method according to claim 1, wherein the first and second confidential job information comprise one of print job information for performing a printing operation; copy job information for performing a copying operation; scan job information for performing a scanning operation; facsimile transmission/reception job information for transmitting/receiving a facsimile; and e-mail transmission/reception job information for transmitting/receiving an e-mail.

8. An image processing method comprising:
a first transmitting step of transmitting first confidential job information and user identifying information; and
a receiving step of receiving information about whether or not unprocessed second confidential job information, other than the first confidential job information, corresponding to the user identifying information exists.

9. The image processing method according to claim 8, further comprising a display step of displaying a list of one or more pieces of said second confidential job information.

10. The image processing method according to claim 9, further comprising a second transmitting step of transmitting confidential job information to be processed that has been selected from the displayed list of the second confidential job information.

11. The image processing method according to claim 8, further comprising a third transmitting step of transmitting an input password for the first confidential job information.

12. The image processing method according to claim 10, further comprising a third transmitting step of transmitting an input common password for the first confidential job information and the selected second confidential job information.

13. The image processing method according to claim 8, wherein the first and second confidential job information comprise one of print job information for performing a printing operation; copy job information for performing a copying operation; scan job information for performing a scanning operation; facsimile transmission/reception job information for transmitting/receiving a facsimile; and e-mail transmission/reception job information for transmitting/receiving an e-mail.

14. An image processor comprising:
first receiving means for receiving first confidential job information and user identifying information;
search means for searching for unprocessed second confidential job information, other than the first confidential job information, corresponding to the user identifying information; and
transmitting means for transmitting a notice if the second confidential job information is found.

15. The image processor according to claim 14, further comprising executing means for executing processing of the first and/or second confidential job information when instructions to execute the first and/or second confidential job information are provided by inputting a password.

16. The image processor according to claim 15, wherein the executing means simultaneously processes the first and second confidential job information when instructions to execute the first and second confidential job information are provided.

17. The image processor according to claim 14, further comprising:
second receiving means for receiving a first password corresponding to the first confidential job information;
input means for inputting a second password by a user for executing the first confidential job information; and
executing means for executing processing of the first confidential job information if the first password matches the second password.

18. The image processor according to claim 17, further comprising password setting means for setting the first password, which is for the first confidential job information, to the password for the second confidential job information if the second confidential job information is found.

19. The image processor according to claim 14, wherein the search means searches for the second confidential job information if the first confidential job information is received after a predetermined time has elapsed since the previous confidential job information was received, but does not search for it if the predetermined time has not elapsed.

20. The image processor according to claim 14, wherein the first and second confidential job information comprise one of print job information for performing a printing operation; copy job information for performing a copying operation; scan job information for performing a scanning operation; facsimile transmission/reception job information for transmitting/receiving a facsimile; and e-mail transmission/reception job information for transmitting/receiving an e-mail.

21. An image processor comprising:
first transmitting means for transmitting first confidential job information and user identifying information; and
receiving means for receiving information about whether or not unprocessed second confidential job information, other than the first confidential job information, corresponding to the user identifying information exists.

22. The image processor according to claim 21, further comprising display means for displaying a list of one or more pieces of said second confidential job information.

23. The image processor according to claim 22, further comprising second transmitting means for transmitting confidential job information to be processed that has been selected from the displayed list of the second confidential job information.

24. The image processor according to claim 21, further comprising third transmitting means for transmitting an input password for the first confidential job information.

25. The image processor according to claim 23, further comprising third transmitting means for transmitting an input common password for the first confidential job information and the selected second confidential job information.

26. The image processor according to claim 21, wherein the first and second confidential job information comprise one of print job information for performing a printing operation; copy job information for performing a copying operation; scan job information for performing a scanning operation; facsimile transmission/reception job information for transmitting/receiving a facsimile; and e-mail transmission/reception job information for transmitting/receiving an e-mail.

27. A computer-readable storage medium storing a control program which allows a computer to execute the method of claim 1.

28. An image processing method comprising:
receiving information about a first job to be output;
receiving a user ID associated with the first job;
determining whether a second job corresponding to the user ID was previously output; and
generating a notification signal if it is determined that the second job was previously output.

29. The image processing method of claim 28, further comprising indicating that the first job is a confidential job.

30. The image processing method of claim 29, wherein the second job is a confidential job.

31. The image processing method of claim 30, further comprising:
receiving authentication information corresponding to the user ID; and
using the authentication information to execute both the first confidential job and the second confidential job.

32. The image processing method of claim 31, wherein the step of determining further comprises searching a storage device to determine whether the second job was previously output.

33. The image processing method of claim 32, wherein the step of searching occurs after a predetermined time.

34. The image processing method of claim 28, further comprising generating a display list having the first and the second jobs, wherein the display list optionally allows the second job to be selected for output.
